(19) United States
(12) Patent Application Publication
(10) Pub. No.: US 2011/0029394 A1
(43) Pub. Date: Feb. 3, 2011

(54) SYSTEM, METHOD AND COMPUTER PROGRAM FOR MANAGING ADVERTISEMENTS ON WEB OR SAP PAGES

(75) Inventor: Marko NORDBERG, Helsinki (FI)

Correspondence Address: LUCAS & MERCANTI, LLP, 475 PARK AVENUE SOUTH, 15TH FLOOR, NEW YORK, NY, 10016, US

(73) Assignee: CVON INNOVATIONS LIMITED, LONDON (GB)

(21) Appl. No.: 12/872,326

(22) Filed: Aug. 31, 2010

Related U.S. Application Data
(63) Continuation of application No. PCT/US2009/001807, filed on Mar. 23, 2009.
(60) Provisional application No. 61/070,749, filed on Mar. 25, 2008.

(51) Int. Cl. G06Q 30/00

(52) U.S. Cl. 705/14.73

(57) ABSTRACT

System, method and computer program for delivering data to a terminal using a communications network. Displayable data having a content part and a first advertisement part is provided to the terminal and the terminal is monitored to detect a request for a second, alternate advertisement part. When this occurs, the requested second advertisement part is delivered to the terminal via the communications network. The second advertisement part is displayed on the terminal instead of the first advertisement part and together with the same content part.

### CROSS-REFERENCE TO RELATED APPLICATION

This is a continuation application of PCT International Application No. PCT/US2009/001807 filed Mar. 23, 2009, which claims priority of U.S. Provisional Application Serial No. 61/070,749 filed Mar. 25, 2008, the entire disclosure of each of which is incorporated herein by reference.

### FIELD OF THE INVENTION

The present invention relates generally to systems, methods and computer programs for managing advertisements on Web or WAP pages. The present invention also relates to systems, methods and computer programs for advertising using the Internet.

### BACKGROUND INFORMATION

Mobile terminals, such as mobile phones, laptops, personal digital assistants (PDA), multimedia computers and the like, can be used for browsing Internet (Web) pages and mobile Internet (Web and WAP) pages and content in the Web and WAP pages.

One method for sponsoring content in the Web and WAP pages, as well as services for the mobile terminals, is through the use of advertisements present in the Web and WAP pages or delivered in connection with the content or services. A typical implementation is to include a banner advertisement in a Web or WAP page, for example, placing the banner in the top of the page.

To optimize the effectiveness of advertisements, the advertisement, i.e., the banner, placed in the Web or WAP page is often selected based on, for example, the consumer's profile, the content of the web or WAP page or web site providing the Web or WAP page, the network location of the consumer and the like. Advertisements can be offered by the owner of the web site, a third-party advertisement aggregator, search provider and others.

The banner is typically a “clickable” banner, i.e., when the consumer accessing the Web or WAP page with the banner clicks on the banner, information about the advertised product or service in the banner is provided to the user in the same browser window, a new window or a pop-up window of the browser or other application. It is a drawback of this technique that the original content page is no longer visible to the consumer, i.e., it is partially or entirely covered by the information about the advertised product or service.

In mobile terminals, this is an even bigger problem than with terminals with large screens, such as laptops and personal computers (PC), since the windowing system of the mobile terminals might not be able to handle multiple windows in view of the relatively small size of the screen thereof. Although JavaScript, Flash and similar technologies are available to users of mobile terminals in order to manage windows generated by clicking banner advertisements, the users of mobile terminals often have limited support and resources to use these. Also, these technologies generally do not allow interaction with advertisements to continue when the user is moving between different Web or WAP pages of a web site.

### SUMMARY OF THE INVENTION

The present invention is directed at least in part to a system, method and computer program for managing advertisements on Web or WAP pages while allowing a user to continue to view the same content page. That is, the user can interact with different advertisements while continue to view the same content portion of a Web or WAP page.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a schematic of an architecture in which an advertising system in accordance with the invention can be used.

FIG. 2 is a schematic of a prior art advertising system.

FIG. 3 is a schematic of an advertising system in accordance with the invention.

FIG. 4 is a diagram showing an application of the advertising system in accordance with the invention.

### DETAILED DESCRIPTION

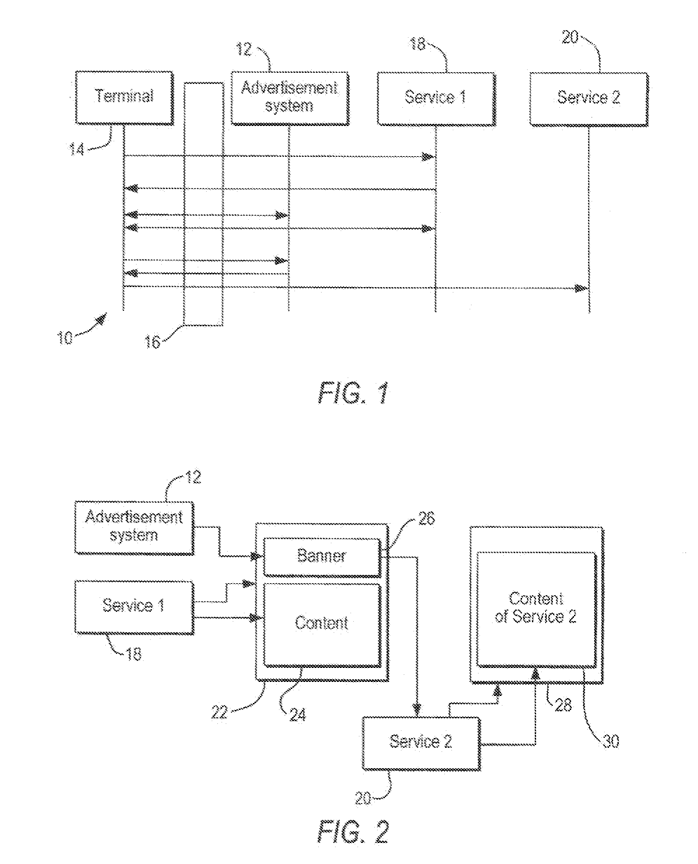

Referring to the accompanying drawings wherein the same reference numerals refer to the same or similar elements, FIG. 1 shows a first embodiment of an architecture in which an advertising system in accordance with the invention can be used. The advertising system is designated generally as 10 and may be implemented to provide subsidized or even free mobile telecommunications services, the subsidy being provided by advertisers whose advertisements are being directed to subscribers of the mobile telecommunications service.

The system 10 includes one or more advertisers, defined to include any and all entities, or individuals that want to advertise products or services to customers participating in the mobile marketing arrangement, and an advertisement management system 12 that is operated by, for example, an advertising delivery company.

Advertisers can “thus refer to a brand owner, a service provider, an advertisement agent, a merchant or any other party that wants to provide advertisements to consumers. Advertisements can be commercial, such as a product or service promotion, or non-commercial, such as a general information service notification. An advertiser can also be a store having a physical presence, an on-line store and the like, which sell or deliver goods and provide services directly to users ordering via the Internet or their mobile terminals 14 (only one of which is shown in FIG. 1).

Typically, the operator of the advertisement management system 12 is a company in the business of delivering advertisements from several advertisers, i.e., it is the intermediary between advertisers and the operators of the advertisement distribution channels. Operation of the advertisement management system 12 is typically managed over an Internet interface, and may include one or more interfaces to external systems.

The advertisement management system 12 preferably includes tools for each advertiser to define rules of their advertisement campaign, i.e., to enable them to tailor the advertisement campaign to their specific desires. This may include reserving, programming and/or booking an advertising campaign via an Internet interface. Parameters which are determined include, but are not limited to, the time period or periods when to send advertisements, the duration of the advertising campaign, the target group or groups, demographics of the target group (s), the format or type of advertisement, the target price level or cost per advertisement or for the advertising campaign in its entirety, the target feedback level of the advertisement, the sociological background of the target audience, interests as declared by the target group(s), demographics of the target group(s) including, for example, age, sex and income level(s), keywords related to the advertisement, a type of Web or WAP site to associate with the advertisement, target telephone type, location of the consumer, etc. An advertiser may also be able to define a set of keywords related to the addressing advertisements to communication sessions between users and/or between users and content services.

In one embodiment, there is an auction of allocatable advertisements and messages to be sent to the users of the mobile terminals 14. As such, advertisers can participate in an auction and bid for the predetermined advertising blocks.

In addition to determining the rules, each advertiser typically provides one or more actual advertisements to the advertising management system 12 in the form of data, text, pictures, video, audio, Flash animations, Portable Document Format (PDF) documents, links, television content, videos, Hypertext Markup Language (HTML), Extensible markup language (xml), Extensible Hypertext Markup Language (xHTML), Wireless Application Protocol (WAP) pages, web pages, etc., or any digital content compatible for reception and display by the users' mobile terminal 14.

The preferences, settings, advertisements, messages, texts, figures, keywords and other rules set by the advertisers relating to the delivery and tagging of communications involving the advertisements may be stored in a database resident in or otherwise associated with the advertisement system 12.

Mobile terminal 14 is arranged to use a communications network 16 to communicate with the advertisement management system, 12 and other elements of the system 10 described below. communications network 16 can utilize any cellular network technologies that include, but are not limited to, Global System for Mobile Communications (GSM), Wideband Code Division Multiple Access (WCDMA), Code Division Multiple Access (CDMA) and General Packet Radio Service (GPRS). In addition to traditional cellular networks, local area networks such as Wireless Local area networks (WLAN), BlueTooth (BT) and other technologies such as Worldwide Interoperability for Microwave Access (WiMax), Broadcasting over Digital Video Broadcasting-Handheld (DVB-H), Integrated Services Digital Broadcasting-Terrestrial (ISDB-T), (Digital Multimedia Broadcasting) DMB or broadcasting over cellular can be used, e.g., to deliver advertisements as discussed below. The communications network 16 can also be a generic Internet access network using any data transport methods. Moreover, the communications network 16 may be any cellular, broadcast, wide area, local area or Internet network. communications network 16 can also be a combination of different communications networks such as a Wireless Local Area Network (WLAN) and a Wideband Code Division Multiplex (WCDMA) network. Using the foregoing network(s), the advertisements from advertisers can be Short Message Service (SMS) messages, Multimedia Message Service (MMS) messages, WAP Push, Web pages, or any digital object.

Subscribers to the mobile telephone operator using the mobile terminals 14 can use the same communications network or another communications network as the communications network 16 being used to deliver advertisements from advertisers via the advertisement management system 12, i.e., a hybrid network is possible.

The mobile terminals 14 may be any form of mobile terminal such as a mobile telephone, a smart telephone, a multimedia computer, a personal digital assistant (PDA), a laptop computer or a personal computer. Further, the mobile terminals 14 may be connected to the communications network 16 by means of a wireless and/or wired communication link. For a GSM network, the link between the mobile terminals 14 and the communications network 16 is wireless. At a minimum, the mobile terminals 14 have the capability to communicate with one or more different type of communications networks and have messaging capabilities in the form of a messaging client system such as a short message service (SMS) client system, an e-mail client system, or a multimedia message service client system embedded in the mobile terminal 14. Additionally, mobile terminals 14 may also include a browser to access Web and/or WAP services.

An advertisement can be delivered to the users' mobile terminals 14 via the communications network 16. The communications network 16 may be any cellular, broadcast, wide area, local area or Internet network. Cellular communications network 16 includes network elements, such as WAP gateways and Internet gateways, and may be connected to the Internet via one or more of these gateways to enable access to target Internet sites or services 18, 20 for the users of the mobile terminals 14. The Internet services 18, 20 may be Web or WAP pages, or other services like games and applications.

To obtain Internet services 18, 20, a user of the mobile terminal 14 must use the communications network 16 which in turn is connected to the advertisement management system 12, and this allows for the creation of particular Web or WAP pages being requested by the user of the mobile terminal 14 from the Internet services 18, 20. Specifically, one or more of the advertisements stored in a database in advertisement management system 12 or in a database accessible thereby, can be added or inserted into Web and WAP pages being provided to the mobile terminal 14.

In one embodiment, base stations for radio communications and other elements, interfaces and functional components necessary to operate, manage and control communications network 16 may be provided, such as a Short Message Service Center (SMSC) and a Multimedia Message Service Center (MMSC).

System 10 may also include a billing system coupled to the advertisement management system 12 and/or the communications network 16 or specific parts thereof, and may be arranged to monitor and/or meter usage and payments of or for the advertisements being delivered to each mobile terminal 14 by the advertisement management system 12. The billing system may be a real-time billing system or a close-to-real-time billing system.

FIG. 1 includes arrows showing the data flow. Mobile terminal 14 requests services from Internet service 18 and 20 via the advertisement management system 12 and the communications network 16. Each Internet service 18, 20 provides the requested service to the mobile terminal 14 via the advertisement management system 12 and the communications network 16. Mobile terminal 14 also requests an advertisement from advertisement management system 12 which provides the requested advertisement to the mobile terminal 14, both via the communications network 16.

The architecture shown in FIG. 1 is used in prior art advertising techniques as well as advertising techniques in accordance with the invention. FIG. 2 is a diagram showing a prior art advertising technique using a banner advertisement. Initially, the mobile terminal 14 (the content of the screen thereof being shown in FIG. 2) accesses Internet Service 18 via communication network 16 and provides a web page 22 including a content part 24 and advertisement part 26 (the banner) which is displayed on the screen of the mobile terminal 14. For example, the Internet service 18 send mobile terminal 14 a hyper text markup language (HTML) description of the web page 22 which includes a part that defines a URL (universal resource locator) for the banner advertisement 26 in the web page 22. The web browser in the mobile terminal 14 fetches elements of the web page 22 from appropriate locations, for example, the content part 24 from a web server of Internet service 18 and the banner 26 from advertisement management system 12.

If the user of the mobile terminal 14 clicks on the banner 26 in the web page 22, the URL related to a link associated with the banner 26 directs the web browser of the mobile terminal 14 to communicate with advertisement management system 12, e.g., by formulating an http request thereto. The http request to the advertisement management system 12 typically includes information about the web site in which the banner 26 has been embedded, as well as a server providing the banner 26. Then, the web browser opens a new window and is directed to Internet service 20 via a redirect instruction or other instructions from the advertisement management system 12 which are based on the content of the banner 26. Internet service 20 provides a new web page 28 having a content part 30 for display in the newly opened window. The content part 30 is based on the advertised product or service in banner 26.

As such, in this prior art method, a new browser window is opened and the user's mobile terminal is directed to a web site for the product or service advertised in the banner 26. The original content page 22 is closed or it is partially or completely covered by the newly opened window for web page 28 with content part 30, and thus the content part 24 in the original web page 22 is no longer visible to the user.

The present invention maintains the original content part of a web page which also contains a banner when the user clicks on the banner in order to obtain information about an advertised product or service.

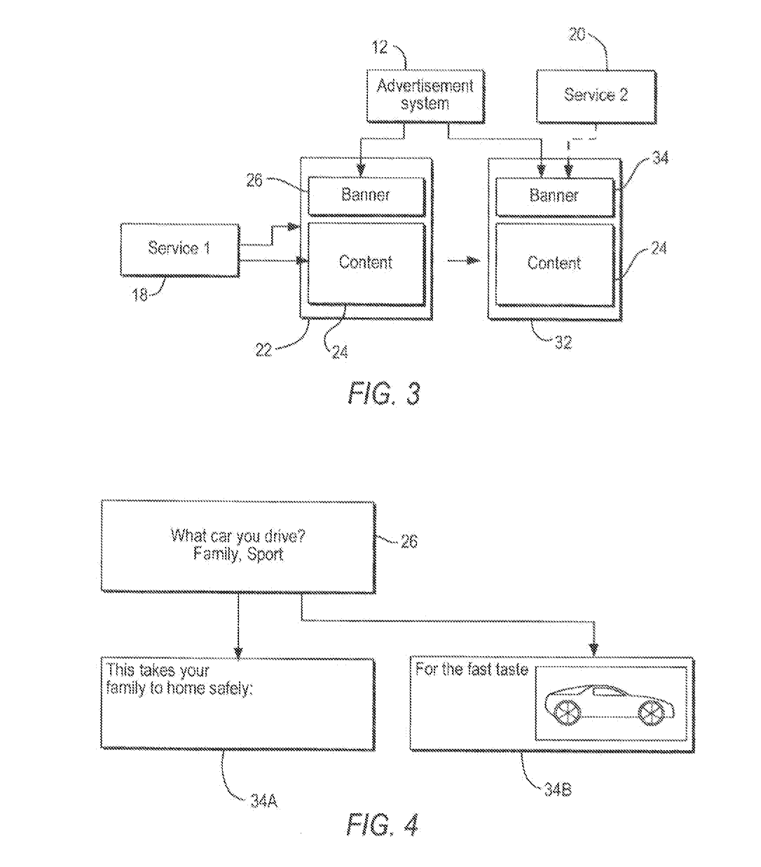

Referring to FIG. 3, in one embodiment of the invention, when the user clicks on the banner 26, the content part 24 is not changed and/or the user is not redirected to new URL. Rather, only the banner 26 is changed. Thus, when the user of the mobile terminal 14 clicks on the banner 26 in the web page 22, the URL related to a link associated with the banner 26 directs the web browser of the mobile terminal 14 to communicate with advertisement management system 12, e.g., by formulating an http request thereto. The advertisement management system 12 therefore monitors a request for another banner from the mobile terminal 14. Alternatively, other components of the advertising system 10 may monitor a request from the mobile terminal 14 for another banner, i.e., a second banner to insert instead of the first banner 26 currently in the web page 22. For example, the Internet service 18, 20 may monitor such requests.

Upon receipt of the request for an alternate banner to display instead of banner 26, the advertisement management system 12 may provide instructions to the web browser of the mobile terminal 14 to obtain the alternate banner. The instructions may be for the web browser to be directed to advertisement management system 12, or alternatively to an Internet service 20, via a redirect instruction or other instructions from the advertisement management system 12 which may be based on the content of the banner 26.

Advertisement management system 12 or Internet service 20 provides only a new banner 34 with the content part 24 remaining unchanged, and thereby creating a new web page 32 which is displayed by the mobile terminal 14. The instructions to the mobile terminal 14 may indicate that the content part 24 is not to change and/or that the mobile terminal is not to access a new URL.

In this manner, the user can continue viewing the content part 24 from the original web page 22 provided by the Internet service 18, yet still interact With advertisements.

The source of banners 26, 34 may be the advertisement management system 12 or the same or different Internet services 18, 20. Thus, for example, the initial banner 26 may originate from advertisement management system 12 which selects a banner from any number of different advertisers and different advertisements which are available to it, as discussed above. Banners 26, 34 may also come directly from the same or different advertisers.

In an exemplifying embodiment of this technique, banner 26 may include clickable areas designated “Family” and “Sport” (see FIG. 4). If the user selects the area designated “Family”, the mobile terminal 14 would be instructed to change the banner 26 to another banner 34A for a Volvo family-style automobile with banner 34A replaces banner 26. Content part 24 would remain on the display of the mobile terminal 14. On the other hand, if the user selects the area designated “Sport”, the mobile terminal 14 would be directed to show a banner 34B for a sports car which replaces banner 26. Again, content part 24 would not change.

There is no limitation on the paths or links of the banners and thus, if the user clicks on banner 34A, 34B, the web browser of their mobile terminal 14 may be directed to provide another banner from the advertisement management system 12, Internet service 18, 20 or another Internet service or advertiser and so on.

Any one of the banners 26, 34 used in the invention may include a question with selectable options, such as “what kind of advertisements would you like to see here: 1) Drinks, 2) Clothes, 3) Electronics”. Based on the user' s response to the question, the subsequently displayed banner would be selected from one or more available banners which relate to the options set forth in the initial banner.

If the mobile terminal 14 does not support clickable image maps (for example, it does not have a pointing device), the advertising techniques described above can be achieved using multiple images and a layout that makes them appear as one image.

The present invention also provides several techniques to manage and keep track of the banners 34 being provided or delivered to the mobile terminal 14. Thus, the advertisement management system 12 could gather and store data about which banners 34 are shown, when they are shown and to which mobile terminals 14 they are provided. The advertisement management system 12 could also be arranged to ensure that each banner 34 is shown a minimum number of times.

One technique to keep track of which banners 34 are shown entails arranging the advertisement management system 12, or other service or system which monitors requests for the banner 34 from the mobile terminal 14, to include monitoring or tracking information with the request for banner 34. Thus, the URL of the banner 34 in the web page being provided or delivered to the mobile terminal 14 would change. An example of web traffic showing this addition of information to the request for a banner 34 is as follows:
Content page is received:
Request: GET http://service.com/page.cgi
Response: <a
   href=“http://service.com/page.cgi?ad_id=2”> <img
   href=“http://ads.com/ad.cgi?ad_id=1”> </a>
Request: GET http://ads.com/ad.cgi?ad_id=1
Response: [image 1data here]
Banner is clicked:
Request: GET http://service.com/page.cgi?ad_id=2
Response: <a
   href=“http://service.com/page.cgi?ad_id=3”> <img
   href=“http://ads.com/ad.cgi?ad_id=2”> </a>
Request: GET http://ads.com/ad?ad_id=1
Response: [image 2 data here]

Modification of the request from mobile terminal 14 to monitor the banner 34 being requested and provided to the mobile terminals 14 may be implemented in any of the disclosed embodiments of the invention.

In another embodiment for tracking banners 34 being provided or delivered to the mobile terminals 14, the advertisement management system 12, or other system which monitors requests for banner 34 from mobile terminal 14, keeps tracks of banners 34 being requested by the mobile terminal 14 using cookies. Each time the user of the mobile terminal requests a new banner 34, by clicking on a currently displayed banner 26, the advertisement management system 12 causes the web page 32 to be reloaded (i.e., content part 24 and banner 34 to be retrieved) while delivering or otherwise providing a cookie to the mobile terminal 14 during the reloading of the web page 32. The original web page 22 may originate from the HTTP referrer field, or alternatively, as URL parameter or be coded to cause the addition of service memory for each banner 34. An example of web traffic showing the insertion of a cookie to keep track of banners 34 is as follows:

Page is received:
Request: GET http://service.com/page.html
Response: <a href=“http://ad.com/ad selector”> <img
href=“http://ads.com/ad.cgi”> </a>
Request: GET http://ads.com/ad.cgi

Request: Cookie: ad_id=1

Response: [image 1 data here]
Banner is clicked:
Request: GET http://ad.com/ad selector
Request: Referrer: http://service.com/page.html
Response: Set-Cookie: ad_id=2
Response: Location: http://service.com/page.html
Request: GET http://service.com/page.html
Response: <a href=“http://ad.com/ad selector”> <img
href=“http://ads.com/ad.cgi”> </a>
Request: GET http://ads.com/ad.cgi
Request: Cookie: ad_id=2
Response: [image 2data here]

Several computer programs resident on computer-readable media may be used in the invention. One computer program is resident in the advertisement management system 12, monitors requests for content and advertisements from the mobile terminal 14 and arranges for the delivery of both content and advertisements to the mobile terminals 14 via the communications network 16. Another computer program may be resident in the mobile terminal 14 and manages outgoing requests for Web and WAP pages, and different parts thereof, and reception of displayable data such as advertisements from the advertisement management system 12 or other source of displayable data and content from the Internet services 18, 20.

In the context of this document, computer-readable medium could be any means that can contain, store, communicate, propagate or transmit a program for use by or in connection with the method, system, apparatus or device. The computer-readable medium can be, but is not limited to (not an exhaustive list), electronic, magnetic, optical, electromagnetic, infrared, or semiconductor propagation medium. The medium can also be (not an exhaustive list) an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The medium can also be paper or other suitable medium upon which a program is printed, as the program can be electronically captured, via for example, optical scanning of the paper or other medium, then compiled, interpreted, or otherwise processed in a suitable manner, if necessary, and then stored in a computer memory. Also, a computer program or data may be transferred to another computer-readable medium by any suitable process such as by scanning the computer-readable medium.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention as defined by the appended claims.

1. A system for delivering data to a terminal using a communications network, comprising:
means for providing displayable data to the terminal, the data having a content part and a first advertisement part; and
means for monitoring a request from the terminal for a second, alternate advertisement part via the communications network and instructing said means for providing displayable data to the terminal to provide the requested second advertisement part;
the requested second advertisement part being deliverable to the terminal via the communications network to enable the second advertisement part to be displayed instead of the first advertisement part and together with the same content part.

2. The system of claim 1, wherein said means for providing displayable data comprise at least one of: 1) an advertisement management system arranged to provide the first advertisement part and an Internet service arranged to provide the content part, and 2) an advertisement management system arranged to provide the first advertisement part and at least one Internet service arranged to provide the content part and the second advertisement part.

3. The system of claim 1, wherein said means for monitoring a request from the terminal for the second advertisement part are at least one of: 1) arranged to instruct the terminal not to change the content part, 2) arranged to instruct the terminal not to access a new universal resource locator in order to display the same content part and the second advertisement part, 3) arranged to monitor a request from the terminal for a third, alternate advertisement part and instruct said means for providing displayable data to the terminal to provide the requested third advertisement part, the requested third advertisement part being deliverable to the terminal via the communications network to enable the third advertisement part to be displayed instead of the second advertisement and together with the same content part, and 4) arranged to select the second advertisement part based on a profile of or other information about a user of the terminal, based on the content part, based on information content of an Internet site from which the content part has been requested, or based on information about a category of the Internet site from which the content part has been requested.

4. The system of claim 1, wherein the first advertisement includes at least one of: 1) at least one activatable area, said means for monitoring a request from the terminal for the second advertisement part being arranged to detect when the at least one activatable area is activated and consider activation of the at least one activatable area a request for the second advertisement part, and 2) a query and a plurality of activatable areas indicative of responses to the query, said means for monitoring a request from the terminal for the second advertisement part being arranged to detect when one of the activatable areas is activated, consider activation of the activatable area a request for the second advertisement part and select an advertisement part to constitute the second advertisement part based on the area which has been activated.

5. The system of claim 1, wherein the second advertisement part includes at least one of: 1) at least one activatable area, said means for monitoring a request from the terminal for the third advertisement part being arranged to detect when the at least one activatable area of the second advertisement part is activated and consider activation of the at least one activatable area a request for the third advertisement part, and 2) a query and a plurality of activatable areas indicative of responses to the query, said means for monitoring a request from the terminal being arranged to detect when one of the activatable areas is activated, consider activation of the activatable area a request for the third advertisement part and select an advertisement part to constitute the third advertisement part based on the area which has been activated.

6. A system for delivering data to a terminal using a communications network, comprising:
at least one content provider for providing a content part of a display page to the terminal via the communications network; and
an advertisement management system for providing advertisement parts for the display page to the terminal, said advertisement management system being arranged to monitor a request from the terminal for a second, alternate advertisement part via the communications network;
the requested second advertisement part being deliverable to the terminal via the communications network to enable the second advertisement part to be displayed instead of the first advertisement part and together with the same content part.

7. The system of claim 6, wherein said advertisement management system is at least one of: 1) arranged to provide the second advertisement part, 2) arranged to instruct the terminal not to change the content part, and 3) arranged to instruct the terminal not to access a new universal resource locator in order to display the same content part and the second advertisement part.

8. The system of claim 6, wherein the first advertisement includes at least one of: 1) at least one activatable area, said advertisement management system being arranged to detect when the at least one activatable area is activated and consider activation of the at least one activatable area a request for the second advertisement part, and 2) a query and a plurality of activatable areas indicative of responses to the query, said advertisement management system being arranged to detect when one of the activatable areas is activated, consider activation of the activatable area a request for the second advertisement part and select an advertisement part to constitute the second advertisement part based on the area which has been activated.

9. The system of claim 6, wherein said advertisement management system is further arranged to at least one of: 1) monitor a request from the terminal for a third, alternate advertisement part, the requested third advertisement part being deliverable to the terminal via the communications network to enable the third advertisement part to be displayed instead of the second advertisement part and together with the same content part, 2) select the first or second advertisement part based on a profile of or other information about a user of the terminal, based on the content part, based on information content of an Internet site from which the content part has been requested, or based on information about a category of the Internet site from which the content part has been requested, 3) keep track of the requested second advertisement part by modifying the request for the second advertisement part, and 4) keep track of the requested second advertisement part by delivering a cookie to the terminal along with the second advertisement part.

10. The system of claim 9, wherein the second advertisement part includes at least one of: 1) at least one activatable area, said advertisement management system being arranged to detect when the at least one activatable area of the second advertisement part is activated and consider activation of the at least one activatable area a request for the third advertisement part, and 2) a query and a plurality of activatable areas indicative of responses to the query, said advertisement management system being arranged to detect when one of the activatable areas of the second advertisement part is activated, consider activation of the activatable area a request for the third advertisement part and select an advertisement part to constitute the third advertisement part based on the activatable area which has been activated.

11. A method for delivering data to a terminal using a communications network, comprising:
monitoring a request from the terminal for a content part of a display page from an Internet or mobile service via the communications network;
providing the content part to the terminal;
providing a first advertisement part to the terminal to be displayed with the content part on the display page; monitoring a request from the terminal for a second, alternate advertisement part via the communications network;
providing the requested second advertisement part to the terminal; and
displaying the second advertisement part on the display page instead of the first advertisement part and together with the same content part.

12. The method of claim 11, wherein the step of displaying the second advertisement part on the display page instead of the first advertisement part and together with the same content part comprises at least one of: 1) instructing the terminal not to change the content part, and 2) instructing the terminal not to access a new universal resource locator in order to display the same content part and the second advertisement part.

13. The method of claim 11, wherein at least one of: 1) the first advertisement part includes at least one activatable area, the step of monitoring a request from the terminal for the second advertisement part comprising detecting when the at least one activatable area is activated and considering activation of the at least one activatable area a request for the second advertisement part, and 2) the first advertisement part includes a query and a plurality of activatable areas indicative of responses to the query, the step of monitoring a request from the terminal for the second advertisement part comprising detecting when one of the activatable areas is activated, and considering activation of the activatable area a request for the second advertisement part, the step of providing the second advertisement part comprising selecting an advertisement part to constitute the second advertisement part based on the area which has been activated.

14. The method of claim 11, further comprising:
monitoring a request from the terminal for a third, alternate advertisement part via the communications network;
providing the requested third advertisement part to the terminal; and
displaying the third advertisement part on the display page instead of the second advertisement part and together with the same content part.

15. The method of claim 11, further comprising selecting the first or second advertisement part based on a profile of or other information about a user of the terminal, based on the content part, based on information content of an Internet site from which the content part has been requested, or based on information about a category of the Internet site from which the content part has been requested.

16. A computer program resident on computer-readable media and arranged to manage delivery of displayable data to a terminal using a communications network, the computer program being arranged to:
monitor a request from the terminal for a content part of a display page from an Internet or mobile service via the communications network;
arrange for delivery of the content part to the terminal;
arrange for delivery of a first advertisement part to the terminal to be displayed with the content part on the display page;
monitor a request from the terminal for a second, alternate advertisement part via the communications network; and
arrange for delivery of the requested second advertisement part to the terminal such that the second advertisement part can be displayed on the display page instead of the first advertisement part and together with the same content part.

17. The computer program of claim 16, wherein the computer program is further arranged to at least one of: 1) communicate with an Internet service to arrange for delivery of the content part to the terminal and communicate with an advertisement management system to arrange for delivery of the first advertisement part to the terminal, 2) communicate with the advertisement management system to arrange for delivery of the second advertisement part, 3) communicate with at least one Internet service to arrange for delivery of the content part and the second advertisement part to the terminal and communicate with an advertisement management system to arrange for delivery of the first advertisement part to the terminal, 4) instruct the terminal not to change the content part when displaying the content part and the first or second advertisement part, 5) monitor a request from the terminal for a third, alternate advertisement part via the communications network; and arrange for delivery of the requested third advertisement part to the terminal such that the third advertisement part can be displayed on the display page instead of the second advertisement part and together with the same content part, 6) select the second advertisement part based on a profile of or other information about a user of the terminal, based on the content part, based on information content of an Internet site from which the content part has been requested, or based on information about a category of the Internet site from which the content part has been requested, 7) keep track of the requested second advertisement part being delivered to the terminal, 8) keep track of the requested second advertisement part by modifying the request from the terminal for the second advertisement part via the communications network, and 9) keep track of the requested second advertisement part by arranging for delivery of a cookie to the terminal along with the second advertisement part.

18. The computer program of claim 16, wherein at least one of: 1) the first advertisement part includes at least one activatable area, the computer program being further arranged to detect when the at least one activatable area is activated and consider activation of the at least one activatable area a request for the second advertisement part, and 2) the first advertisement part includes a query and a plurality of activatable areas indicative of responses to the query, the computer program being further arranged to detect when one of the activatable areas is activated, consider activation of the activatable area a request for the second advertisement part, and select an advertisement part to constitute the second advertisement part based on the area which has been activated.

19. The computer program of claim 16, wherein at least one of: 1) the second advertisement part includes at least one activatable area, the computer program being further arranged to detect when the at least one activatable area in the second advertisement part is activated and consider activation of the at least one activatable area a request for the third advertisement part, and 2) the second advertisement part includes a query and a plurality of activatable areas indicative of responses to the query, the computer program being further arranged to detect when one of the activatable areas in the second advertisement part is activated, consider activation of the activatable area a request for the third advertisement part, and select an advertisement part to constitute the third advertisement part based on the activatable area which has been activated.

20. A computer program resident on computer-readable media and arranged to manage delivery of displayable data to a terminal using a communications network, the computer program being arranged to:
request content part of a display page from an Internet or mobile service via the communications network;
request a first advertisement part to be displayed with the content part on the display page;
receive the requested content part and first advertisement part and display the content part and first advertisement part on a common window;
request a second, alternate advertisement part via the communications network;
receive the requested second advertisement part; and
display the content part and second advertisement part on a common window whereby the second advertisement part is displayed instead of the first advertisement part and together with the same content part.

21. The computer program of claim 20, wherein the computer program is further arranged to at least one of: 1) communicate with an Internet service to arrange for delivery of the content part and communicate with an advertisement management system to arrange for delivery of the first advertisement part, 2) communicate with the advertisement management system to arrange for delivery of the second advertisement part, 3) communicate with at least one Internet service to arrange for delivery of the content part and the second advertisement part and communicate with an advertisement management system to arrange for delivery of the first advertisement part, 4) not change the content part when displaying the content part and the first or second advertisement part, 5) request a third, alternate advertisement part via the communications network; receive the requested third advertisement part; and display the content part and the third advertisement part on a common window whereby the third advertisement part is displayed instead of the second advertisement part and together with the same content part, and 6) request the second advertisement part based on a profile of or other information about a user of the terminal, based on the content part, based on information content of an Internet site from which the content part has been requested, or based on information about a category of the Internet site from which the content part has been requested.

22. The computer program of claim 20, wherein the first advertisement part includes at least one of: 1) at least one activatable area, the computer program being further arranged to detect when the at least one activatable area is activated and consider activation of the at least one activatable area a request for the second advertisement part, and 2) a query and a plurality of activatable areas indicative of responses to the query, the computer program being further arranged to detect when one of the activatable areas is activated, consider activation of the activatable area a request for the second advertisement part, and request an advertisement part to constitute the second advertisement part based on the area which has been activated.

23. The computer program of claim 20, wherein the second advertisement part includes at least one of: 1) at least one activatable area, the computer program being further arranged to detect when the at least one activatable area in the second advertisement part is activated and consider activation of the at least one activatable area a request for the third advertisement part, and 2) a query and a plurality of activatable areas indicative of responses to the query, the computer program being further arranged to detect when one of the activatable areas in the second advertisement part is activated, consider activation of the activatable area a request for the third advertisement part, and request an advertisement part to constitute the third advertisement part based on the activatable area which has been activated.
